(19) United States
(12) Patent Application Publication
(10) Pub. No.: US 2006/0118748 A1
(43) Pub. Date: Jun. 8, 2006

(54) Electrical drain valve

(76) Inventors: Marcela Franco-Sola, Zapopan (MX); Roberto Villanueva-De Vega, Zapopan (MX)

Correspondence Address: KNOBBE MARTENS OLSON & BEAR LLP, 2040 MAIN STREET, FOURTEENTH FLOOR, IRVINE, CA, 92614, US

(21) Appl. No.: 11/003,846

(22) Filed: Dec. 3, 2004

(51) Int. Cl. F16K 31/02

(52) U.S. Cl. 251/129.21

(57) ABSTRACT

A drain valve electrically operated to drain contaminants out of air containers connected to a pneumatic system is disclosed. The drain valve comprises a valve structure defining a drain conduit means extending longitudinally therethrough and means for electrically controlling the drain of the contaminants out of the container. A solenoid coil assembly inside the drain valve is activated by a current signal applied thereto by actuating a switch near the user, thereby causing the solenoid coil to create an electromagnetic field on the valve body, which moves a piston member within a chamber from a sealing position in which the drain outlet of the valve is closed to a unsealing position in which said drain outlet remains open to discharge the contaminants out of the tank. When the current signal is interrupted, the piston member is not more attracted by the generated electromagnetic force and returns to the valve sealing position as a result of the pressure of air contained in the air tank.

### BACKGROUND OF THE INVENTION

1. Field of the Invention

It is disclosed herein an electrically controlled drain valve to facilitate the drain of air tanks of any pneumatic system used to operate pneumatic tools such as dental equipment, pneumatic drills, air brakes for buses, trains, etc. Conveniently, the operation of the drain valve can be electrically controlled from a distance by the user by simply activating an electrical switch placed near him.

2. Prior Art

Any pneumatic system that works by using pressurized air as the operation means is constituted by a several elements (mainly compressor, valves and hoses), the replacement parts of which are designed to operate by pressurized air generated by the compressor, said air being stored in metal tanks known as service tanks. The compressor is constituted by a lubricating system, which due to the certain wearing of the cylinder elements and the piston rings causes that an amount of oil mixed with pressurized air passes into the service tanks. The atmospheric (wet) air suctioned by the compressor when said air passes to the tanks is compressed up to a pressure nine times the atmospheric pressure causing the humidity condensates and drops of water are formed when cold, which drops become mixed with the oil vapor and a clear sludge is produced. This contaminant is accumulated in the service tanks and it must be drained out of the air tanks every 24 hours as a measure of the preventive maintenance to prevent said contaminant from passing to the air hoses and obstructs the conducts producing damages in the elements of the pneumatic system.

One problem resulting in the long run from not draining daily the aforesaid contaminant is a significant reduction of the lifetime of the pneumatic system components because they are not made from anticorrosive materials. Consequently, the acid produced by the combination of the oil-water mixture and the metallic structure of the air tank besides the decomposition of the oil constituting agents causes an accelerated deterioration of the pneumatic system components.

The drain operation of service air tanks to eliminate thereof the contaminants (wet air mixed with water, oil and impurities) should be carried out at least every 24 hours. However, as this operation is presently carried out manually by opening a conventional draining valve directly where the tank is located, users often forget or dislike doing this maintenance routine, which causes damages in the system.

Failure to drain daily pneumatic systems as recommended may be due to very different reasons: laziness, the difficult access either of the drain valve means or the air tanks, climate conditions, lack of tools and even ignorance of maintenance personal. The result is that the drain operation is not carried out at appropriate time intervals such that the contaminant enters the pneumatic system. The accumulation of contaminants inside the air tanks reduces the storage capacity thereof and the efficiency of the pneumatic system. This circumstance causes the compressor to work much more than necessary and consequently lifetime of different parts of the pneumatic system, namely hoses, connections, air tanks, regulator, diaphragms, valves and even the compressor become shortened to 70%, because the contaminant may not only damage the metallic elements but also rubber elements as a result of the derivatives of hydrocarbons contained in oil, which causes high costs due to corrective maintenance.

### SUMMARY OF THE INVENTION

The present invention has been conceived to overcome the aforementioned problems by providing a new drain valve by which the drain operation of air tanks is very easy for the user. To this end, a new design of an electrically operated drain valve is proposed consisting of few elements that work efficiently and safely to facilitate the maintenance service of pneumatic systems.

One primary object of the new drain valve is to make easy the maintenance operation so that it may be carried out every 24 hours as recommended so as to promote a more prolonged lifetime of the elements and replacements of the pneumatic system being connected to the air tank, thereby increasing the efficiency of said system and reducing the costs of corrective maintenance.

Another object of the invention is to propose a new electrical valve capable of being actuated from a distance, said valve being activated by an operator by means of a contact switch that allows an electrical current to circulate through a solenoid coil to generate an electromagnetic field concentrated on the valve body whereby an attraction force is exerted on a piston member associated operatively with a drain plug to control the drain of the contaminants out of the air tank. Displacement of the piston member out of the contact with the associated drain plug unseals a plug outlet orifice, thereby causing the air tanks of any pressurized air actuated pneumatic system to be drained.

The new valve may be installed in the air tanks of any pneumatic system actuated by pressurized air, for example pneumatic drills, tire service centers, dental instruments, brakes for heavy equipment, air tanks of pneumatic system for trains, bus, trucks, etc.

The main object of the invention is to delete the traditional system of manual draining of air tanks of pneumatic systems by using an electrical valve of the type of which will be described hereinafter. The new valve is of simple construction and is characterized by a more efficient and comfortable operation by means of a current switch that may be placed on an instrument panel, near the air tank(s) or anywhere at hand. In addition, the valve is more economical than use of typical hand-operated tools, which become clogged or adhered because of oxidation accumulated therein, which necessitates frequent replacement.

According to one embodiment of the invention, the new drain valve for draining pressurized air tanks comprises:

1) valve arrangement including:
a) a valve body having a bore extending longitudinally therethrough and a first threaded portion to be fastened threadably to the outlet orifice of an air tank;
b) a solenoid coil assembly comprising a generally cylindrical hollow member including an annular solenoid coil housing and a first internally threaded section to be fastened threadably to a second threaded portion of said valve body to be connected coaxially in fluid communication therewith; and
c) a removable valve plug having a threaded portion for fastening threadably to a second internally threaded section of said cylindrical hollow member to be connected coaxially in fluid communication therewith; said plug further includes a drain hole extending longitudinally therethrough and being in fluid communication with said valve body bore;
d) a cylindrical sleeve fastened to said valve body for covering the solenoid annular housing; and

2) drain controlling means comprising a chamber in fluid communication with said valve body bore and the plug drain hole; a piston member movable within the chamber from a valve sealing position in which said plug drain hole is closed to a valve unsealing position in which said plug drain hole is open and contaminants may be drained out of the valve; and electrically powered means placed in said annular housing to cause the displacement of said piston from said valve sealing position to said valve opening position when a current signal is applied to said electrically powered means.

Alternatively, an additional embodiment of the new drain valve would be conformed as follows:

1) a valve arrangement including:
a) a hollow valve body having a threaded portion for connection with the outlet orifice of the air tank and a bore extending longitudinally through said valve body; said valve body further including a solenoid annular housing;
b) a removable valve plug having a threaded portion for fastening threadably to the valve body, said valve plug further including a drain hole extending longitudinally therethrough and being in fluid communication with said valve body bore;
c) a cylindrical sleeve fastened to said valve body for covering the solenoid annular housing; and

2) drain controlling means comprising a chamber in fluid communication with said valve body bore and said the plug drain hole; a piston member movable within the chamber from a valve sealing position in which said plug drain hole is closed to a valve unsealing position in which said plug drain hole is open and contaminants may be drained out of the valve; and electrically powered means placed in said annular housing to cause the displacement of said piston from said valve sealing position to said valve opening position when a current signal is applied to said electrically powered means.

### BRIEF DESCRIPTION OF THE DRAWINGS

FIG. 1 is a side view of the electrical decompression valve of the present invention.

FIG. 2 is a cut-away view of one embodiment of the electrical valve to show the interior structure thereof.

FIG. 3 is a front view of the electrical decompression valve.

FIG. 4 is a rear view of the electrical decompression valve.

FIG. 4A is cut-away view of the valve to show the slot made in the outlet of the valve body bore leading to the piston chamber.

FIG. 5 is a cut-away and exploded view of another embodiment of the electrical drain valve to show the internal structure thereof.

FIG. 5A is a view of the second embodiment of the drain valve.

FIG. 6 is a front view of the second embodiment of drain valve.

FIG. 7 is a rear view of the second embodiment of drain valve.

FIG. 8 is a cut-away view of the valve showing the piston element in the closed position.

FIG. 9 is a cut-away view of the valve showing the piston element in the open position.

### DETAILED DESCRIPTION OF THE PREFERRED EMBODIMENT

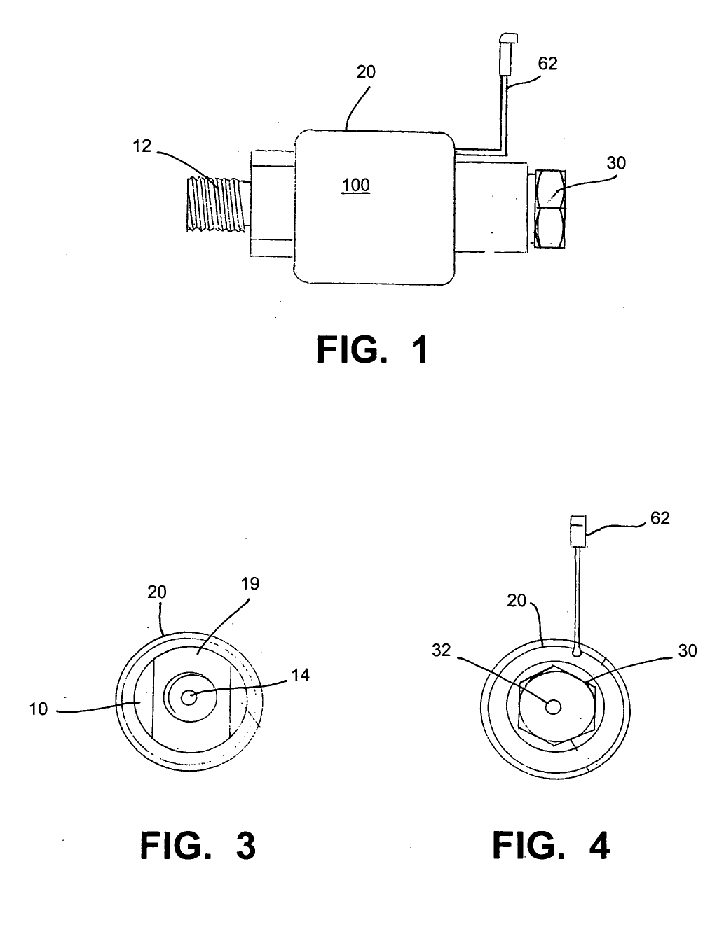

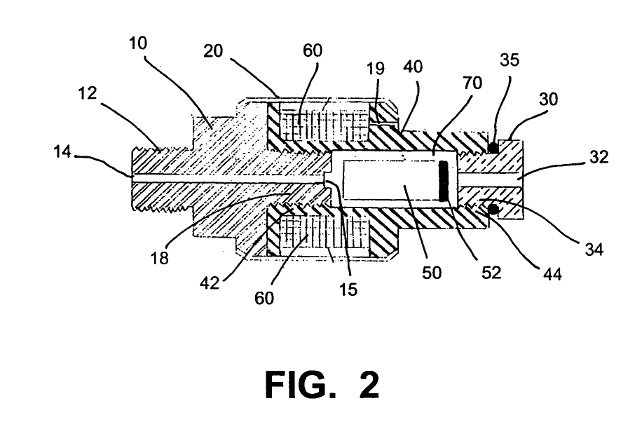

With reference to FIGS. 1-4, in a first embodiment the electrical drain valve (100) is structurally formed by a valve arrangement comprising a valve body (10), a coil housing (40) and a valve plug (30), all of them having thread means for coaxial connection therebetween. As shown in FIG. 2, said coil housing (40) acts as a coupling element to be connected threadably with said valve body (10) and said valve plug (30) in fluid communication. In addition, the valve arrangement includes a metallic cylindrical sleeve (20) fastened by any appropriate means to the valve body (10) and the coil housing (40) so as to cover and isolate an electrically powered means, namely a solenoid coil (60) placed around the coil housing (40). The sleeve (20) is intended to concentrate the electromagnetic field generated by said solenoid coil (60) substantially on said valve body (10) when a current signal is applied to said electrically powered means (60).

The valve body (10) is a substantially circular member having a first threaded portion (12) to be fastened threadably to the drain orifice of the air tank (not shown) in place of a conventional drain valve. Further, valve body (10) has a longitudinal bore (14) extending therethrough to permit the pass of contaminants to be extracted from the air tank. The plug (30) of the drain valve has a longitudinal hole (32) through which the contaminants of the air tank are drained out of same.

The valve body (10) and the valve plug (30) are provided with threaded portions (18, 34, respectively) for connection with corresponding female threaded sections (42, 44) in the coil housing (40). Connection of these three elements (10, 30, 40) forms a drain conduit through which the contaminants accumulated in the air tank(s) are drained out of the valve upon activation of the electrical valve. In addition, as observed in FIG. 2, elements (10, 30, 40) define jointly a cylindrical chamber (70) through which a piston member (50) moves from a valve sealing position in which said plug drain hole is closed to a valve unsealing position in which said plug drain hole is open and contaminants may be drained out of the air tank depending on the application of an electrical signal to the drain valve.

The piston (50) is a cylindrical member having a rubberized end (52) or provided with another sealing material so as to promote an airtight seal contact with said plug hole (32). According to the principles of the invention, while pressurized air exits in the tank, said piston (50) will be urged to close the plug hole (32) and prevent the air from escaping.

The other opposite end of valve body (10) is a second threaded male portion (18) having a greater diameter than the diameter of the first end portion, said second portion (18) is to be connected with the threaded section (42) of coil housing (40). The surface of portion (18) facing to the chamber has a slot (15) extending diametrically in order that the contaminants can flow out of the valve despite said piston member (50) is in contact with the valve body (10) as a result of the electromagnetic field generated by the solenoid coil (60) upon application of an electrical signal.

The coil housing (40) is a substantially cylindrical hollow member made preferably of a low conductivity metal, i.e. brass or bronze. Further, coil housing (40) has a spool-shaped section around which said a solenoid coil (60) is wounded.

Conveniently, the top of the valve plug (30) has a hexagonal shape for facilitating its removal from or placement threadably to the valve by any conventional tool whenever necessary to replace the piston (50) or cleaning the chamber. As shown in FIG. 2, the plug threaded portion (34) inserted into the coil housing (40) acts as a seat element on which the piston rubberized end contacts to seal the drain outlet (32) when the valve is not powered electrically and the pressurized air pushes the piston member against said valve plug (30). Valve plug (30) has a circular rib (136) around the plug hole (32) and preferably said plug is made of a low or null conductivity metal, i.e. brass or bronze, or a non-metal material.

FIG. 3 corresponds to the front view of the drain valve which as observed therein has a generally circular shape. Here, it can be seen the valve body (10), the circular contour of the sleeve (20) covering the solenoid coil (60) and the threaded portion (12) by which said drain valve is fastened to the air tank. In addition, as can be seen in FIG. 3, the valve body (10) has a rectangular section (19) suitable to tighten or loosen the drain to the air tank by a conventional tool.

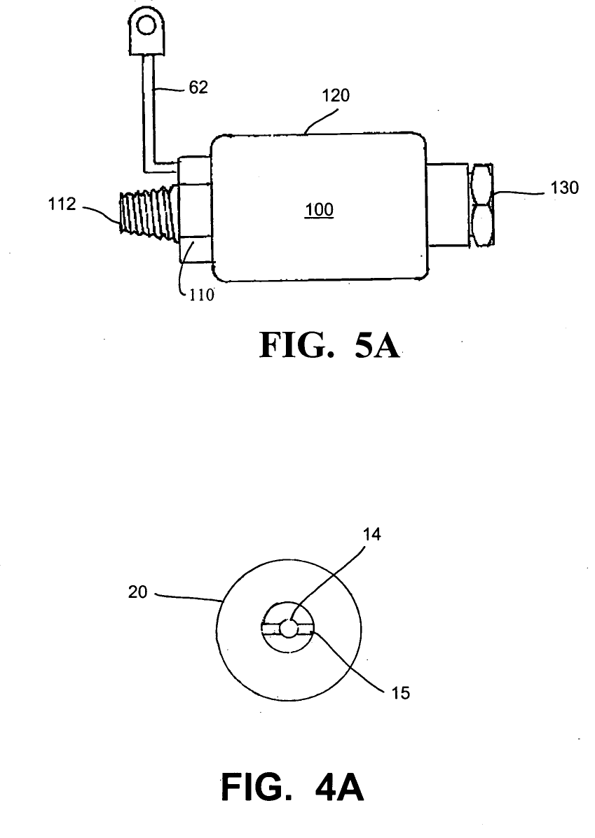

In turn, FIG. 4 corresponds to the opposite view of the electrical drain valve and here it is observed the coil housing (40) and the valve plug (30) including the drain hole or outlet (32) through which the contaminants are drained out of the air tank. Furthermore, a cable (62) to connect said solenoid coil (60) to an electrical circuit for activating the valve is shown in FIG. 4. The other terminal (not shown) of the solenoid coil is grounded by attaching same to the valve body by any appropriate means (e.g. welding).

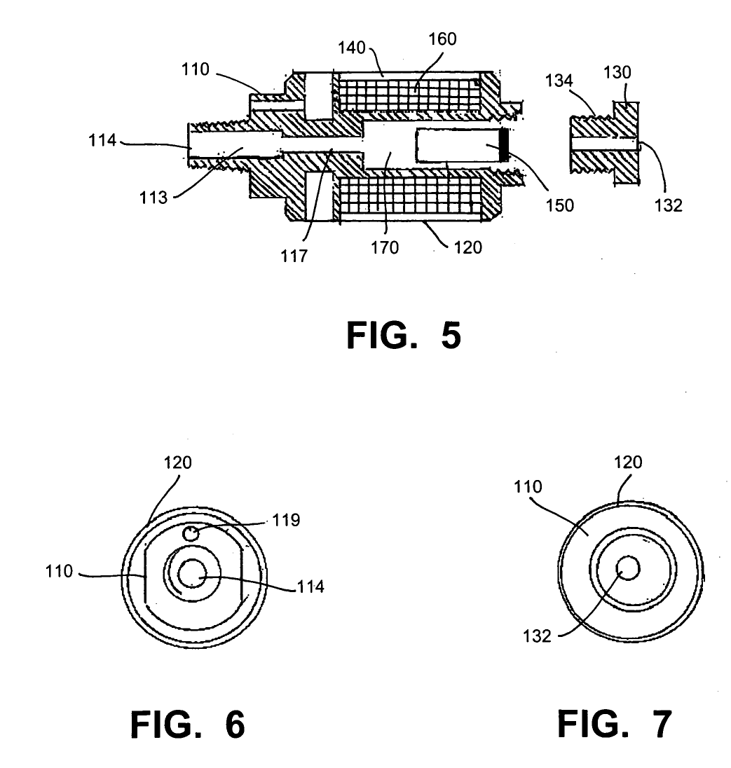

Another embodiment of the invention is depicted in FIGS. 5-9. The new valve (100) comprises a single valve body arrangement (110) and a removable valve plug (130) coaxially connected threadably in fluid communication. In combination, said valve body (110) and said valve plug (130) define the chamber (170) through which the piston member (150) moves from a sealing position to an opening position upon activation of the electrically powered means (160) placed inside the valve. As can be noted by comparing FIGS. 2 and 5 illustrating both valve embodiments, as distinguished from the firstly described valve, the second drain valve proposes a simplest valve structure because said second valve avoids using two separate elements, namely a valve body (10) and a coil housing (40), to conform the main structure of the drain valve.

An additional distinctive feature of said drain valve (100) is a drain bore (114) in said valve body (110), which is formed by two passageways (113, 117) of different diameters, the outermost diameter (close to the tank outlet orifice) being greater than the diameter closest to the piston chamber (170). The proposed reduction of the bore diameters will cause the exit pressure and velocity of the fluid to be higher so that any oxidation particles, water and oil generated in the tank is expulsed out of the air tank without any difficulty. As a result of this special configuration of the drain bore (114), it would be then unnecessary to provide a slot at the conduit orifice leading to the piston chamber, as suggested for the first embodiment.

As in the first embodiment, the valve body arrangement includes a solenoid coil housing (140) to receive therein a solenoid coil (160) and a cylindrical sleeve (120) to cover said solenoid housing (140). Similarly, an orifice (119) for a solenoid cable is provided in drain valve to connect electrically the solenoid coil to an electrical supplying source.

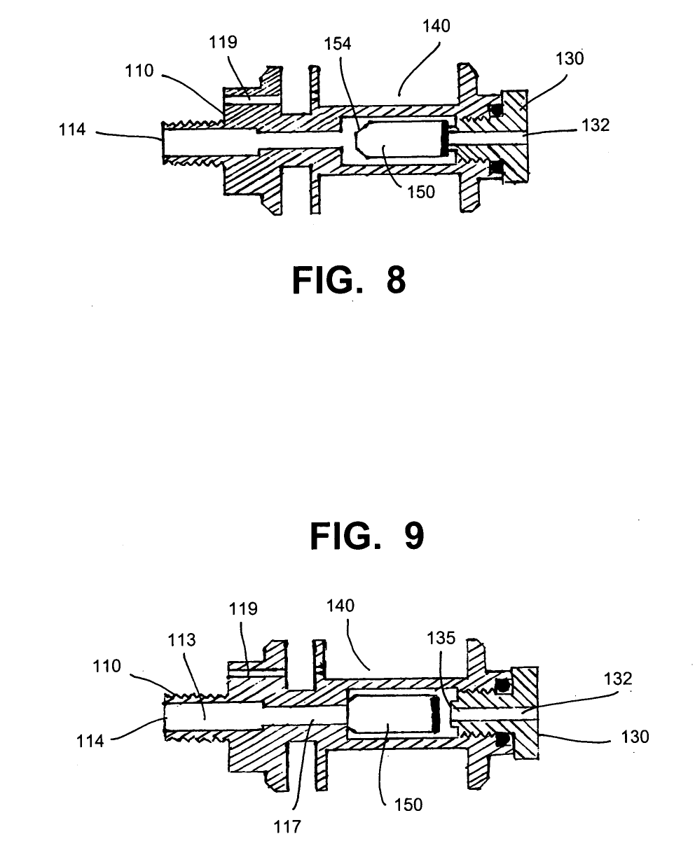

As depicted in FIGS. 8 and 9, the piston member (150) may be designed in such a manner as to include a beveled section (154) at the piston end facing the valve body bore (114) to facilitate the drain of the contaminants. Also, a circular rib (135) in the plug surface contacting the piston member for sealing the valve may be provided to ensure a proper airtight seal. In both embodiments, the valve plug (30, 130) further includes an O-ring sealing element (35) to close tightly the drain conduit of the said valve.

Mode of Operation of the Drain Valve

The drain valve is placed in fluid communication with the drain orifice of an air tank, which is fed by a compressor to maintain the pressure of air needed by a pneumatic system to work. The new drain valve is placed where a conventional drain valve is usually connected to the air tank.

When pressurized air exits in the tank, said pressurized air passes through the drain bore (14) into the piston chamber (70) of the valve body (10) so that the air pressure pushes the piston member (50) toward the valve plug (30) so that the rubberized end (52) of said piston obstructs the drain hole (32), as shown in FIG. 8. In this position, the drain hole of the valve remains hermetically sealed to prevent the pressurized air contained in a service tank from escaping.

When desired to operate the drain valve to drain the contaminants from the tank, a user actuates a switch placed conveniently at hand, which is connected electrically to the valve solenoid coil (60) so that an electrical current circulates through the solenoid coil to create an electromagnetic field in the valve body (10), thereby causing that the piston (50) moves into the valve body (10), leaving the plug drain hole (32) unobstructed to allow the contaminants (water, oil and impurities) can be drained out of the tank. The power of the solenoid coil is chosen to be able to move the piston member to the unsealing position shown in FIG. 9 and keep said piston in said unsealing position while the electrical signal is being applied.

For the specific embodiment of the drain valve depicted in FIG. 2, the drain of contaminants out of the tank when the piston member (50) is in contact with the valve body (10), the radial surface of threaded portion (18) of said valve body (1) has a slot (15) in fluid communication with the drain bore (14) of body (10). The depth of the slot (15) is only sufficient to permit the flow of the contaminants through it into the drain outlet of the valve.

When the user switches the electrical current signal off, piston (50) is not more attracted by the valve body and the piston member returns to the sealing position (FIG. 8) to close tightly the drain hole (32) as a result of the force of the pressurized air accumulated in the tank.

In accordance with the preceding description, the new drain valve offers the following features:
a) Due to the diminishing of the diameter of the drain outlet in the valve plug in comparison with the diameter of the piston chamber, the drain of fluid out of the tank is faster. Further, because of the higher pressure at the outlet, undesirable particles are expulsed out of the tank.
b) Even though the electrical system may fail, the security of the pneumatic system is guaranteed because no leakage of pressurized air would be produced due to the free action of the piston.
c) Because of the manufacture of the solenoid coil, the latter may be operated at any time.
d) As a result of features of fabrication and quality of materials of the drain valve, the lifetime of this is longer and the costs cheaper than those of the drain valves being used presently.
e) Because of the small size of the valve and the possibility to be operated from a distance, air tanks may be placed at protected and safer locations.

f) When oxidized residues are accumulated because of a prolonged period of wear, often the conventional drain valves get clogged and then the air tanks cannot be drained which necessitates replacement. Contrarily, the new valve overcomes such inconvenience because it has a drain plug having a top in a hexagonal shape or any other convenient means to facilitate the removal of same to extract the sealing piston to clean it or replace it whenever necessary. This operation of maintenance is less expensive than the replacement of the conventional drain valves.
g) Because of the technical and design features of the new drain valve, it may be used to drain air tanks for any pneumatic system.

As mentioned hereinbefore, the new drain valve is useful for draining tanks used in pneumatic systems being used to operate air brakes for buses, medical dental equipment, tools and equipment for car maintenance service, pneumatic systems for trains, etc.

In view of the above, the new valve offers important aspects such as security, efficiency and economy, which have not been achieved before by a similar drain device.

A very important aspect of the invention is a new drain valve that may be placed far from the air tanks and near the user so that said valve can be activated by an electrical switch when desired to drain said air tanks.

The new valve can be installed at any pressurized air tank forming a part of pneumatic systems being used in heavy operation machinery and systems.

While particular embodiments of the invention have been described, it should be understood that the invention claimed is not limited to the shown embodiments since it is believed that other modifications and changes within the scope of the invention may result from the teachings set forth hereinbefore. Accordingly, the invention is not limited to the embodiments described hereinbefore but is defined by the appended claims.

What is claimed is:

1. An electrical drain valve for draining air tanks of pneumatic systems, comprising:
1) a valve arrangement comprising:
a) a valve body having a bore extending longitudinally therethrough and a first threaded portion to be fastened threadably to the outlet orifice of an air tank;
b) a solenoid coil assembly comprising a generally cylindrical hollow member comprising an annular solenoid coil housing and a first internally threaded section to be fastened threadably to a second threaded portion of said valve body to be connected coaxially in fluid communication therewith; and
c) a removable valve plug having a threaded portion for fastening threadably to a second internally threaded section of said cylindrical hollow member to be connected coaxially in fluid communication therewith; said plug further comprises a drain hole extending longitudinally therethrough and being in fluid communication with said valve body bore;
d) a cylindrical sleeve fastened to said valve body for covering the solenoid annular housing; and
2) a drain controlling means comprising a chamber in fluid communication with said valve body bore and said plug drain hole; a piston member movable within the chamber from a valve sealing position in which said plug drain hole is closed to a valve unsealing position in which said plug drain hole is open and contaminants may be drained out of the valve; and electrically powered means placed in said annular housing to cause the displacement of said piston from said valve sealing position to said valve opening position when a current signal is applied to said electrically powered means.

2. The electrical drain valve of claim 1, wherein said valve body, solenoid coil assembly and valve plug define jointly a drain conduit extending from said tank orifice outlet to outside the valve, and they also define said chamber for displacement of said piston member from the sealing position to the unsealing position of the valve.

3. The electrical drain valve of claim 1, wherein said electrically powered means may be operated from a distance to activate the drain valve thereby draining the contaminants out of the tank.

4. The electrical drain valve of claim 1, wherein said electrically powered means comprises a solenoid coil for connection with an electrical current supplying source to create an electromagnetic field on the valve body when receiving a signal of electrical current.

5. The electrical drain valve of claim 1, wherein the electromagnetic field generated by the solenoid coil moves the piston member into contact with said valve body, thereby opening the plug drain hole such that the contaminants may be drained out of the air tank.

6. The electrical drain valve of claim 1, wherein the piston member has a rubberized end portion to produce an airtight contact with the plug drain hole as a result of the pressurized air contained in the tank.

7. The electrical drain valve of claim 1, further comprising an orifice through which an electrical connecting element of the solenoid coil emerges for connection with an electrical current supplying source.

8. The electrical drain valve of claim 1, wherein the solenoid coil is grounded by attaching a solenoid terminal to the valve body.

9. The electrical drain valve of claim 1, further comprising at least one slot in the second threaded portion of said valve body, said at least one slot being in fluid communication with said valve body bore; the depth of said at least one slot being sufficient to allow the contaminants be removed outside the tank despite the piston member is in contact with said valve body while the electrically powered means are activated.

10. The electrical drain valve of claim 1, wherein said valve plug has a top shaped in such a manner as to facilitate the removal and placement of said plug to the valve body by conventional tools.

11. The electrical drain valve of claim 1, wherein the valve plug further comprises an O-ring element to close tightly the drain conduit of the said valve.

12. The electrical drain valve of claim 1, wherein said valve plug comprises a circular rib in the surface contacting the piston member for sealing the valve.

13. An electrical drain valve for draining air tanks of pneumatic systems, comprising:
1) a valve arrangement comprising:
a) a hollow valve body having a threaded portion for connection with the outlet orifice of the air tank and a bore extending longitudinally through said valve body; said valve body further comprising a solenoid annular housing;
b) a removable valve plug having a threaded portion for fastening threadably to the valve body, said valve plug further comprising a drain hole extending longitudinally therethrough and being in fluid communication with said valve body bore;
c) a cylindrical sleeve fastened to said valve body for covering the solenoid annular housing; and
2) a drain controlling means comprising a chamber in fluid communication with said valve body bore and said plug drain hole; a piston member movable within the chamber from a valve sealing position in which said plug drain hole is closed to a valve unsealing position in which said plug drain hole is open and contaminants may be drained out of the valve; and electrically powered means placed in said annular housing to cause the displacement of said piston from said valve sealing position to said valve opening position when a current signal is applied to said electrically powered means.

14. The electrical drain valve of claim 13, wherein said valve body and said valve plug define jointly a drain conduit extending from said tank orifice outlet to outside the valve, and they also define said chamber for displacement of said piston member from the sealing position to the unsealing position of the valve.

15. The electrical drain valve of claim 13, wherein said electrically powered means may be operated from a distance to activate the drain valve thereby draining the contaminants out of the tank.

16. The electrical drain valve of claim 13, wherein said electrically powered means comprises a solenoid coil for connection with an electrical current supplying source to create an electromagnetic field inside the valve when receiving a signal of electrical current.

17. The electrical drain valve of claim 13, wherein the electromagnetic field generated by the solenoid coil moves the piston member into contact with said valve body, thereby opening the plug drain hole such that the contaminants may be drained out of the air tank.

18. The electrical drain valve of claim 13, wherein the bore of said valve body comprises a first and second coaxial passages having different diameters.

19. The electrical drain valve of claim 13, wherein said first passage is wider than said second passage so that an acceleration effect of the fluid is created to drain the contaminants more rapidly.

20. The electrical drain valve of claim 13, wherein the piston member has a beveled section on the side contacting the valve body to promote a better circulation of the fluid to be drained out of the tank.

21. The electrical drain valve of claim 13, wherein the piston member has a rubberized end portion to produce an airtight contact with the plug drain hole as a result of the pressurized air contained in the tank.

22. The electrical drain valve of claim 13, further comprising an orifice through which an electrical connecting element of the solenoid coil emerges for connection with an electrical current supplying source.

23. The electrical drain valve of claim 13, wherein the solenoid coil is grounded by attaching a terminal of solenoid to the valve body.

24. The electrical drain valve of claim 13, wherein said valve plug has a top shaped in such a manner as to facilitate the removal and placement of said plug to the valve body by conventional tools.

25. The electrical drain valve of claim 13, wherein said valve plug comprises a circular rib in the surface contacting the piston member for sealing the valve.

26. The electrical drain valve of claim 13, wherein the valve plug further comprises an O-ring element to close tightly the drain conduit of the said valve.
